(19) United States
(12) Patent Application Publication
(10) Pub. No.: US 2021/0319518 A1
(43) Pub. Date: Oct. 14, 2021

(54) SYSTEMS AND METHODS FOR GENERATING DAMAGE ASSESSMENTS

(71) Applicant: State Farm Mutual Automobile Insurance Company, Bloomington, IL (US)

(72) Inventors: Ivan D. Hall, Bloomington, IL (US); George T. Dulee, JR., Bloomington, IL (US); Timothy J. Spader, Bloomington, IL (US); Jessica Perganson, Bloomington, IL (US); John H. Jenkins, Bloomington, IL (US)

(21) Appl. No.: 15/055,786

(22) Filed: Feb. 29, 2016

Related U.S. Application Data
(60) Provisional application No. 62/238,336, filed on Oct. 7, 2015.

(51) Int. Cl. G06Q 40/08

(52) U.S. Cl. CPC G06Q 40/08

(57) ABSTRACT

Methods and systems for generating a damage assessment for a damaged property may be provided. The method may include receiving a damage report from a user associated with the damaged property, presenting an eligibility test to the user, and receiving a response to the eligibility test from the user's mobile device and determining whether the user is eligible based upon the response, such as based upon an amount of vehicle damage. The method may electronically activate a damages module on an application stored on the user's mobile device to generate a damage assessment. Based upon how the user sends the damage report, the system may adjust how and when the damage report is generated. In one aspect, functionality is provided that determines whether a damaged vehicle and/or insured is eligible for online vehicle damage estimation (such as based upon a limited extent of vehicle damage) and/or associated online insurance claim submission.

### CROSS-REFERENCE TO RELATED APPLICATIONS

This application is related to U.S. Provisional Patent Application No. 62/238,336, filed Oct. 7, 2015, entitled “SYSTEMS AND METHODS FOR GENERATING DAMAGE ASSESSMENTS,” the entire contents of which is hereby incorporated by reference in its entirety.

### FIELD OF THE INVENTION

The present disclosure relates to insurance claims processing and, more particularly, to systems and methods for generating damage assessments.

### BACKGROUND

Damage to property such as buildings and vehicles due to weather, accidents, and/or other events occurs throughout the country every day. The damage may require repairs, replacements, and/or other costs to fix the property. An owner of the property may insure the property through an insurance provider to limit damage-related costs that the owner has to pay. When the property receives damage, the owner or insurance policy holder may contact the insurance provider to determine how much the damage will cost, and/or whether to submit an insurance claim. However, conventional techniques for estimating damage and/or insurance claim submission may be awkward, inefficient, time consuming, inaccurate, inconvenient, and/or have other drawbacks.

### BRIEF SUMMARY

The present embodiments may relate to providing a damage assessment to a policy holder for a damaged property. In particular, the present embodiments may relate to providing a damage assessment for a damaged property based upon a communication method of the policy holder. A damages assessment system of the present embodiments may include a user computing device, an assessment computing device, an insurance computing device, and/or a claims processing system. The user computing device may store an insurance App associated with an insurance provider. The insurance App may include a damages module. The policy holder may initiate a damage assessment request by reporting the damaged property via the insurance App, an internet application, and/or a telephone call. Based upon the communication method, the system may be configured to receive loss information (e.g., images of the damaged property) from the user and determine the user's eligibility to access the system, such as based upon an extent of vehicle damage in some instances. The system may generate the damage assessment and review the damage assessment for the insurance provider to approve. The system may cause the user computing device to display the damage assessment for the user, and allow the user to submit an associated insurance claim via their computing (e.g., mobile) device.

In one aspect, a computer-based method for generating a damage assessment for a damaged property may be provided. The method may include receiving a damage report from a user associated with the damaged property. The method may further include presenting an eligibility test to the user, receiving a response to the eligibility test from the user, and/or determining that the user is eligible based upon the response. The method may additionally include electronically activating a damages module on an application stored on a user computing device associated with the user and/or generating a damage assessment. The method may include additional, fewer, or alternative steps, including those described elsewhere herein.

In another aspect, a user computer device configured to collect loss information of a damaged property may be provided. The user computing device may include one or more processors and a memory in communication with the processors. The processors may be programmed to receive an activation code. The activation code may be configured to activate a damages module on an application executed on the user computing device. The processors may be programmed to receive loss information from the user through the damages module, the loss information including at least one image of the damaged property and/or transmit the loss information to an assessment computing device. The assessment computing device may be configured to generate a damage assessment. The processors may be further programmed to receive the damage assessment and/or cause the damage assessment to be displayed on the user computing device within the damages module. The user computing device may include additional, fewer, or alternative components and features, including those discussed elsewhere herein.

In yet another aspect, an insurance computing device may be provided. The insurance computing device may include one or more processors and a memory in communication with the processors. The processors may be programmed to receive a response to an eligibility test from the user. The processors may be further programmed to determine that the user is eligible to receive a damage assessment based upon the response and/or notify an assessment computing device that the user is eligible, wherein the assessment computing device is configured to generate the damage assessment. The insurance computing device may include additional, fewer, or alternative components and features, including those discussed elsewhere herein.

In another aspect, at least one non-transitory computer-readable storage media having computer-executable instructions embodied thereon may be provided. The computer-executable instructions, when executed by one or more processors, may cause the processors to receive an activation code. The activation code may be configured to activate a damages module on an Application executed on a user computing device. The computer-executable instructions may further cause the processors to receive loss information from a user through the damages module. The loss information may include at least one image of a damaged property. The computer-executable instructions may further cause the processors to transmit the loss information to an assessment computing device and/or receive the damage assessment from the assessment computing device. The computer-executable instructions may further cause the processors to cause the damage assessment to be displayed on the user computing device within the damages module. Additional, less, or alternate instructions may be provided such as instructions directing the functionality discussed elsewhere herein.

In yet another aspect, at least one non-transitory computer-readable storage media having computer-executable instructions embodied thereon may be provided. The computer-executable instructions, when executed by one or more processors, may cause the processors to receive a response to an eligibility test from a user and/or determine that the user may be eligible to receive a damage assessment based upon the response. The computer-executable instructions may further cause the processors to notify an assessment computing device that the user is eligible. The assessment computing device may be configured to generate the damage assessment. Additional, less, or alternate instructions may be provided such as instructions directing the functionality discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and are instrumentalities shown, wherein:

FIG. 1 illustrates an exemplary damages assessment system for providing damage assessment associated with a damaged property to a policy holder.

FIGS. 2-4 illustrate exemplary user interfaces of an insurance App that may be used in a damages assessment system, such as the system shown in FIG. 1.

FIG. 5 illustrates an exemplary method of providing a damage assessment using an insurance App that may be implemented by a damages assessment system, such as the system shown in FIG. 1.

FIG. 6 illustrates an exemplary method of providing a damage assessment using an internet application that may be implemented by a damages assessment system, such as the system shown in FIG. 1.

FIG. 7 illustrates an exemplary method of providing a damage assessment using telephone call that may be implemented by a damages assessment system, such as the system shown in FIG. 1.

FIG. 8 illustrates an exemplary computing device that may be used by a damages assessment system, such as the system shown in FIG. 1.

FIG. 9 illustrates an exemplary server computing device that may be used by a damages assessment system, such as the system shown in FIG. 1.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION OF THE DRAWINGS

The present embodiments may relate to, inter alia, systems and methods for generating a damage assessment that is initiated by a policy holder for purposes of insurance coverage. In particular, the systems and methods may relate to processing an insurance policy holder's request to receive an estimation or assessment of costs. The request may be, for example, a report of damage to a property (“damage report”) or an insurance claim. The damage assessment may be associated with costs related to repairing or replacing a damaged property (sometimes referred to as “damage costs”). As used herein, a property may include any infrastructure (e.g., a building), vehicle, or other object or location that may be covered by an insurance policy. The system, referred to herein as a damages assessment system, may include a user computing device associated with an insurance policy holder, an assessment computing device, an insurance computing device, and/or a claims processing system. The user computing device, the assessment computing device, the insurance computing device, and/or the claims processing system may be in communication with each other.

The user computing device may be associated with the policy holder or a different user that is associated with an insurance policy. The user computing device may be, for example, a mobile device with one or more processors, a memory, and/or a display. In the exemplary embodiment, the memory of the user computing device may store an insurance App associated with the insurance provider. The insurance App may be configured to enable the policy holder to view, manage, and/or submit insurance-related information. In particular, the insurance App may be configured to enable the policy holder to report property damage (i.e., file an insurance claim), provide information regarding the property damage (such as photographs and/or video of the property damage), and/or display the assessment generated by the assessment computing device.

The insurance App may include a damages module that enables the policy holder to provide images (and/or video) of the damaged property to the insurance provider (also sometimes referred to herein as “loss information”). The images may be used by the assessment computing device to generate the assessment of the damage costs. The damages module may provide instructions to the policy holder for capturing images that facilitate the assessment computing device generating the assessment.

The damages module may be associated with a module identifier that uniquely identifies the damages module for other damages modules. In addition, the module identifier may be associated with the policy holder and/or the user computing device to enable the damages assessment system to identify which assessment is associated with the policy holder. For example, the assessment computing device may receive the module identifier with the information for generating the damage assessment and transmit the assessment to the user computing device based upon the module identifier. The assessment may be presented by the damages module to the policy holder via the display. In some embodiments, the insurance App may display a payment option for the policy holder to pay the assessment.

The damages module of the insurance App may not be accessible by every user computing device including the insurance App. In one example, the insurance App may present one or more eligibility tests to the policy holder to determine if the policy holder is eligible to use the damages module based upon the policy holder's answer(s). In certain embodiments, the eligibility tests may not be presented to the policy holder. The damages assessment system may retrieve information regarding the policy holder and/or the property to automatically determine the eligibility of the policy holder to access the damages module. In the exemplary embodiment, the eligibility tests may be questions regarding the damage property, such as the cause and/or location of the damage to the property. In other embodiments, the damages assessment system may present different eligibility tests to the policy holder and/or present the eligibility tests on a different device. The insurance computing device may receive the policy holder's responses and transmit the responses to the insurance computing device to determine eligibility.

The assessment computing device may be configured to receive information (e.g., images) related to a damaged property, an insurance policy holder, and/or an insurance policy associated with the damaged property from the damages assessment system to generate an assessment of damage costs associated with the damaged property. The assessment computing device may be further configured to determine whether the information received from the damages assessment system is sufficient to generate the assessment. The assessment computing device may upload or transmit the assessment to one or more computing devices of the damages assessment system to be displayed for review by the insurance provider and/or the insurance policy holder.

The insurance computing device may be associated with an insurance provider and/or operated by one or more users associated with the insurance provider (e.g., an insurance claims adjuster). The insurance computing device may be configured to determine the eligibility of the policy holder to receive the assessment via the damages assessment system. In the exemplary embodiment, the insurance computing device or another device may provide one or more questions (also referred to as “eligibility tests”) to the policy holder regarding the property damage. The insurance computing device may receive the policy holder's responses and determine eligibility based upon the responses. The policy holder may not be eligible if, for example, the policy holder does not have a pending insurance claim (i.e., the property is not damaged) or the policy holder did not provide sufficient information for the assessment computing device to generate the assessment. In some embodiments, other options for generating the assessment may be provided by the insurance provider. For example, the insurance provider may provide an option to receive an in-person assessment. The insurance computing device may be further configured to review the assessment generated by the assessment computing device to accept or decline the assessment. If accepted, the insurance computing device may indicate to the policy holder that the assessment is accepted and is pending payment. If declined, the insurance provider may direct the policy holder to alternative insurance claims handling systems associated with the insurance provider.

The claims processing system may be one or more computing devices that receives information from the damages assessment system and initiates tasks performed by other computing devices (e.g., the insurance computing device or the user computing device) to process a plurality of insurance claims. The claims processing system enables the damages assessment system to track and monitor multiple insurance claims at different stages of completion. In the exemplary embodiment, the claims processing system may be coupled to a plurality of insurance computing devices. The claims processing system may determine which insurance computing device receives an insurance claim for handling. The claims processing system may selectively control the user computing device to display insurance-related information to the policy holder as described further below.

The damages assessment system may be configured to enable the policy holder to report the damaged property through multiple communication means. For example, the insurance App on the user computing device may be configured to receive user input indicating the policy holder is reporting the damaged property. In another example, the policy holder may report the damaged property through an interne application such as a webpage or an application associated with the insurance provider in communication with the damages assessment system. In yet another example, the policy holder may report the damaged property by contacting (e.g., a telephone call) the insurance provider. In other embodiments, the policy holder may initiate the damage assessment process through other communication means, such as in-person.

Different communication means may have different steps to provide a damage assessment to the policy holder. Different information may be readily available for each communication means. For example, the policy holder's eligibility to use the damages assessment system may be determined during a phone call from the policy holder before receiving any information regarding the damaged property, whereas the policy holder may submit the information regarding the damaged property before the insurance computing device determines the eligibility of the policy holder. Generally, each communication means may result in the same output to the policy holder (i.e., the damage assessment). However, the communication means may change or alter how the damages assessment system processes the damage assessment as described below.

In the exemplary embodiment, at least one computing device of the damages assessment system (e.g., the assessment computing device, the insurance computing device, the claims processing system, and/or the user computing device) may be configured to detect what communication means the policy holder uses to initiate the assessment process. The damages assessment system may be configured automatically adjust how to process the request for a damage assessment in accordance with the detected communication means.

For example, if the user computing device (or another computing device) detects that the policy holder has reported that a property has been damaged via the insurance App, the user computing device may notify the damages assessment system that the damaged property was reported at the insurance App. The user computing device may launch the damages module to enable the user to submit information associated with the damaged property, such as photos of the damage, and responses to eligibility tests. The user computing device may transmit the information, the responses, and a module identifier to the claims processing systems to select which insurance computing device will handle the policy holder's report. The claims processing system transmits the information, the responses, and/or the module identifier to the selected insurance computing device. An operator of the insurance computing device may determine the eligibility of the policy holder based upon the responses. If the operator determines the policy holder is eligible, the insurance computing device may transmit the information from the policy holder and the module identifier to the assessment computing device. The assessment computing device may generate a damage assessment and transmit the damage assessment back to the insurance computing device. The assessment computing device also may identify the user computing device associated with the module identifier and transmit the assessment to the user computing device for display. The operator of the insurance computing device may review the assessment and approve or disapprove the assessment.

In another example, if the claims processing system (or another computing device) detects that the policy holder has reported a property has been damaged via an internet application, the claims processing system may notify the damages assessment system that the damaged property was reported via the internet application. The internet application may prompt the policy holder to submit information associated with the damaged property and responses to one or more eligibility tests. In some embodiments, the internet application may prompt the policy holder to submit specific information, such as photos of the damaged property. The internet application may receive the information associated with the damaged property and the responses from the policy holder. The internet application may transmit the information and responses to the claims processing system. The claims processing system may select an insurance computing device in communication with the claims processing system to handle the report from the policy holder. The insurance computing device may determine the eligibility of the policy holder based upon the responses. If the insurance computing device determines the policy holder is eligible, the insurance computing device may be configured to identify a module identifier associated with the policy holder. The insurance computing device may be configured to look up the module identifier in a table and/or poll one or more user computing devices to locate the module identifier. The insurance computing device may send the module identifier and the information from the policy holder to the assessment computing device. The assessment computing device may generate an assessment based upon the information and transmits the assessment to the claims processing system for review. The claims processing system may assign an insurance computing device to review the assessment. The assessment computing device may further transmit the assessment to the user computing device using the module identifier to locate the associated user computing device. The damages module may cause the user computing device to display the assessment for the policy holder in response.

In yet another example, the policy holder may contact the insurance provider via a telephone call or another communication means, such as email or instant messaging. In particular, the policy holder may be in communication with the operator of the insurance computing device. When the policy holder initiates the communication with the operator to report the damaged property, the operator may prompt the policy holder to respond to one or more eligibility tests. The operator may determine the eligibility of the policy holder to receive an assessment based upon responses to the eligibility tests. If the policy holder is eligible, the insurance computing device may locate a module identifier associated with the policy holder and transmit the module identifier to the claims processing system. The claims processing system may activate the damages module associated with the module identifier within the insurance App stored on the user computing device associated with the policy holder. In one embodiment, the claims processing system may control the damages module to automatically display on the user computing device. In another embodiment, the claims processing system may communicate with the user computing device to enable the policy holder to access the damages module within the insurance App. Once the damages module is displayed, the damages module may prompt the policy holder to submit information associated with the damaged property, such as photographs. The user computing device may transmit the information from the policy holder and a module identifier of the damages module to the assessment computing device. The assessment computing device may generate the assessment based upon the information from the policy holder and transmit the assessment to the user computing device and the claims processing system for review and Approval.

At least one of the technical problems addressed by this system may include: (i) extended period of time to generate damage assessments; (ii) inflexible damage assessment systems for multiple communication means; (iii) ineligible policy holders may access assessment tools; and/or (iv) issues with identifying individuals that should be granted access to certain insurance claim submission functionality.

A technical effect of the systems and processes described herein may be achieved by performing at least one of the following steps: (a) identifying a communication method used by a policy holder to request a damage assessment on a damaged property; (b) presenting the policy holder with one or more eligibility tests; (c) receiving, from the policy holder, responses to the eligibility tests; (d) determining the eligibility of the policy holder to receive the damage assessment based upon the responses to the eligibility tests; (e) activating a damages module on an insurance application executed on a user computing device; (f) collecting loss information of the damaged property using the damages module; (g) generating the damage assessment based upon the loss information; and/or (h) transmitting the damage assessment to the user computing device and/or an insurance computing device for review.

The technical effect achieved by this system may be at least one of: (i) reduced period of time to generate insurance claims; (ii) flexible damage assessment systems that adjust based upon how the policy holder initiates the request; (iii) assessment tools are accessible only to eligible policy holders and (iv) addressing issues with identifying individuals that should be granted access to certain insurance claim submission functionality.

As used herein, an “insurance policy holder” or “policy holder” refers to a person or business associated with an insurance policy on a property and/or the property itself. For example, the policy holder may include, but is not limited to, an owner of the property, an employee of the owner, a person managing the insurance policy of the property, and/or a third party representing any of the above. The above examples are example only, and are thus not intended to limit in any way the definition and/or meaning of the terms “insurance policy holder” or “policy holder.”

### EXEMPLARY DAMAGES ASSESSMENT SYSTEM

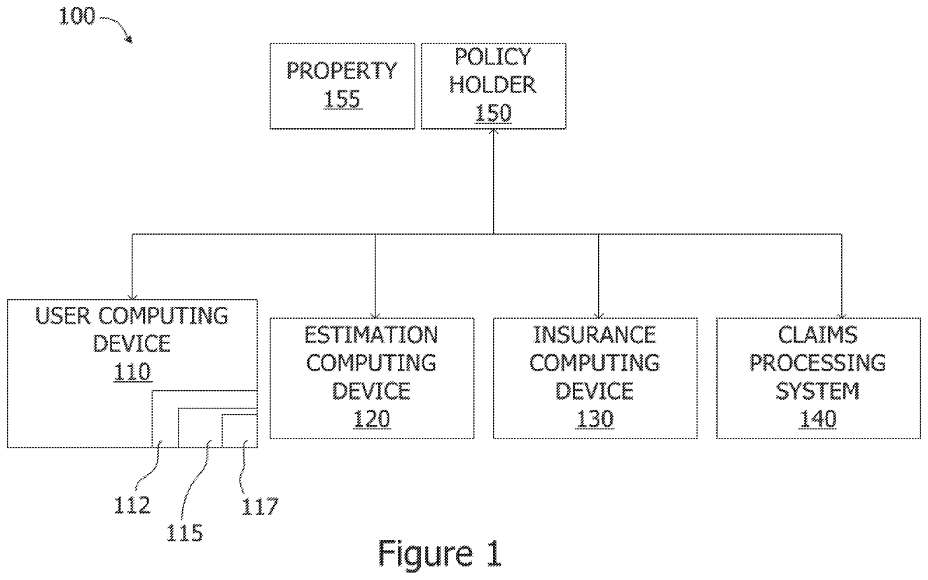

FIG. 1 depicts an exemplary damages assessment system 100 associated with an insurance provider. System 100 may include a user computing device 110, an assessment computing device 120, an insurance computing device 130, and/or a claims processing system 140. System 100 may receive information regarding a damaged property associated with an insurance policy holder and provide a damage assessment based upon the information. System 100 may include additional, fewer, or alternate components, including those discussed elsewhere herein.

In the exemplary embodiment, system 100 may be in communication with a policy holder 150. Policy holder 150 may be associated with a property 155 that is covered by an insurance policy associated with the insurance provider. Property 155 may include, for example, any infrastructure (e.g., a building), vehicle, personal articles, or other object or location that may be covered by the insurance policy. In the exemplary embodiment, property 155 may be damaged. The damage may be caused by weather, fires, accidents (e.g., vehicle collisions), vandalism, and other damaging actions.

Policy holder 150 may attempt to communicate with system 100 to receive a damage assessment related to costs associated with any damage to property 155 (also referred to as “damage costs”). The damage costs may include, without limit, repair costs, replacement costs, and/or other costs that may result from damage to property 155. For example, if property 155 is a vehicle that has been in a collision and is undergoing repairs, the damage costs may include fees for a rental car and repair fees. In another example, if property 155 is a residential building that has fire damage, the damage costs may include hotel fees or living expenses. The insurance policy associated with property 155 may cover at least a portion of the damage to property 155. The insurance provider may cover a portion or all of the damage costs. Policy holder 150 may be liable for the remaining damage costs. Policy holder 150 may wish to view a damage assessment to anticipate future costs of the damage. The assessment may include, among other information, a total cost of the damage, a portion of the total cost that the insurance provider has offered to pay, and/or a portion of the total cost that policy holder 155 is responsible to pay.

Generally, system 100 may receive a report of the damage to property 155 from policy holder 150. In certain embodiments, the report may be an insurance claim and/or a request to receive a damage assessment. In the exemplary embodiment, system 100 may present one or more eligibility tests to policy holder 150 to filter ineligible policy holders from accessing system 100. The eligibility tests may be, for example, a series of questions related to policy holder 150, property 155, the damage to property 155, and/or the insurance policy associated with property 155. In certain embodiments, the eligibility tests may be a different type of test and/or may be conducted without input from policy holder 150. In the exemplary embodiment, system 100 may receive one or more responses to the eligibility tests and determine the eligibility of policy holder 150 based upon the responses.

System 100 may be configured to receive loss information associated with damaged property 155 from policy holder 150. This loss information may include information about policy holder 150, a cause of the damage, a location of the damage, a location of property 155, reports for law enforcement, and/or information related to people, animals, or objects related to the damage (e.g., another person or vehicle involved in a vehicle collision). In the exemplary embodiment, the loss information may include one or more images of property 155 and/or the damage to property 155. The images may include different perspectives and/or image settings to enable the insurance provider or a third party associated with the insurance provider to assess the damage. Additionally or alternatively, the loss information may include video data, audio data, and/or other types of data associated with property 155 and/or the damage to property 155.

System 100 may be configured to generate the damage assessment based upon the loss information for the insurance provider and policy holder 150 to review. The insurance provider may examine the assessment to confirm that the projected coverage amount and other information indicated by the assessment is accurate. The insurance provider may determine that an alternative method or system of processing a damage report for policy holder 150 (e.g., another assessment system) may be desirable or required. For example, the insurance provider may determine that the damage to property 155 requires an in-person examination to provide a damage assessment.

In some embodiments, policy holder 150 may receive the damage assessment and determine to pay the portion of the damage costs indicated by the assessment. System 100 may be configured to enable policy holder 150 to provide payment information to the insurance provider or another party associated with the insurance provider as described further below. The payment information may include, but is not limited to, a payment card number, a financial account number, and/or an account number associated with policy holder 150 at the insurance provider.

As described herein, system 100 may be configured to identify the type of communication method that policy holder 150 used to access system 100. The communication method may be, for example, an App associated with the insurance provider, an interne application, a telephone call with the insurance provider, and/or another method of communicating with the insurance provider. Based upon the communication method, system 100 may adjust when and how information is collected, generated, and/or processed at system 100 to provide the report from policy holder 150 efficiently.

The functions and features described above with respect to system 100 may be performed by user computing device 110, assessment computing device 120, insurance computing device 130, and/or claims processing system 140. In certain embodiments, user computing device 110, assessment computing device 120, insurance computing device 130, and/or claims processing system 140 may be the same device or system.

User computing device 110 may be associated with policy holder 150. In the exemplary embodiment, user computing device 110 may be a mobile device (e.g., a smartphone, laptop, tablet, wearable electronic, smart watch, phablet, notebook, netbook, etc.). User computing device 110 may include a memory 112 that stores an insurance App 115. Insurance App 115 may be associated with the insurance provider. Insurance App 115 may be configured to provide policy holder 150 insurance-related information and options to initiate insurance-related actions, such as reporting damage to property 155. In some embodiments, when policy holder 150 reports damage to property 155, insurance App 115 may be configured to present the eligibility tests to policy holder 150 and receive the responses from policy holder 150.

In the exemplary embodiment, insurance App 115 may include a damages module 117. In certain embodiments, damages module 117 may be a separate App stored in memory 112. Damages module 117 may be configured to collect loss information and display a damage assessment to policy holder 150. Damages module 117 may be accessed through insurance App 115. In the exemplary embodiment, damages module 117 may not be accessible by policy holder 150 until system 100 has transmitted an activation code to insurance App 115 and/or assessment module 117. The activation code may be configured activate or unlock the features and functions of damages module 117 For example, insurance App 115 may disable or remove options related to damages module 117 until receiving the activation code. User computing device 110, assessment computing device 120, insurance computing device 130, and/or claims processing system 140 may be configured to generate and/or transmit the activation code to damages module 117. The activation code may be transmitted in response to system 100 determining that policy holder 150 may be eligible to access system 100.

Damages module 117 may be configured to prompt policy holder 150 to collect loss information associated with damaged property 155. The loss information may include image data (photographs) of property 155. Damages module 117 may submit the loss information to system 100 for generating the damage assessment. In the exemplary embodiment, damages module 117 may further transmit a module identifier to system 100 with the information associated with damaged property 155. The module identifier may be a unique identifier that links the information associated with damaged property 155 to policy holder 150, user computing device 110, insurance App 115, and/or damages module 117. The module identifier enables assessment computing device 120, insurance computing device 130, and/or claims processing system 140 to communicate with the correct user computing device 110.

Damages module 117 may further be configured to receive the damage assessment and present the assessment to policy holder 150. In certain embodiments, damages module 117 may provide policy holder 150 additional assessment details, such as who processed the assessment, a breakdown of the assessment, and/or the information received from policy holder 150. In one embodiment, damages module 117 or insurance App 115 may provide an option to provide payment information to policy holder 150.

Assessment computing device 120 may be configured to receive loss information (e.g., images) related to policy holder 150, property 155, and/or an insurance policy associated with property 155 to generate an assessment of damage costs associated with the damaged property. In the exemplary embodiment, an operator of assessment computing device 120 may assess the information to generate the damage assessment. The operator may be associated with the insurance provider and/or an insurance-related third party. In some embodiments, assessment computing device 120 may further receive a module identifier with the loss information to identify a damages module (e.g., damages module 117) associated with the loss information. Assessment computing device 120 may be further configured to determine whether the loss information is sufficient to generate the damage assessment. If the loss information is determined to be insufficient, assessment computing device 120 may notify the damages module associated with the loss information using the module identifier. If the loss information is determined to be sufficient, assessment computing device 120 may upload or transmit the damage assessment to system 100. In particular, assessment computing device 120 may transmit the assessment to user computing device 110 and/or insurance computing device 130 for review by policy holder 150 and/or the insurance provider, respectively.

Insurance computing device 130 may be associated with the insurance provider. Insurance computing device 130 may be configured to process and manage the damage report of policy holder 150. In particular, insurance computing device 130 may be configured to determine the eligibility of policy holder 150 to access system 100 and/or review the damage assessment generated by assessment computing device 120. Insurance computing device 130 may present policy holder 150 with the eligibility tests and/or receive responses from policy holder 150. Based upon the responses, insurance computing device 130 may determine the eligibility of policy holder 150. In certain embodiments, insurance computing device 130 may automatically determine the eligibility of policy holder 150. Additionally of alternatively, an operator of insurance computing device 130 associated with the insurance provider (e.g., an insurance claims adjuster and/or an insurance agent) may determine the eligibility of policy holder 150. For example, the operator may communicate with policy holder 150 (e.g., via a telephone call) the eligibility tests and input the responses to the eligibility tests into insurance computing device 130. If insurance computing device 130 determines policy holder 150 is ineligible to access system 100, insurance computing device 130 may send policy holder 150 one or more alternative inspection options (e.g., an in-person inspection).

Claims processing system 140 may be one or more computing devices that may be configured to receive information from system 100 (e.g., module identifiers, loss information, a report of damage to property 155, the damage assessment, etc.) and initiate tasks performed by other computing devices (e.g., user computing device 110 or insurance computing device 130) to process a plurality of insurance claims. Claims processing system 140 may enable system 100 to track and monitor multiple insurance claims or damage reports at different stages of completion. In the exemplary embodiment, claims processing system 140 may be coupled to a plurality of insurance computing devices 130. Claims processing system 140 may determine which insurance computing device 130 receives an insurance claim for handling. In some embodiments, claims processing system 140 may selectively control user computing device 110 to display insurance-related information to the policy holder. In one example, claims processing system 140 may cause damages module 117 to activate on user computer device 110 to display the damage assessment generated by estimation module 120.

### EXEMPLARY USER INTERFACES OF AN INSURANCE APP

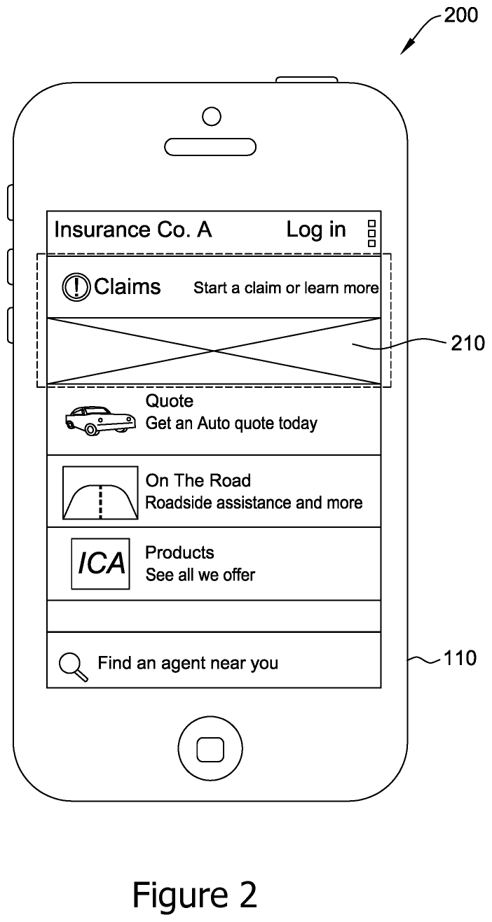

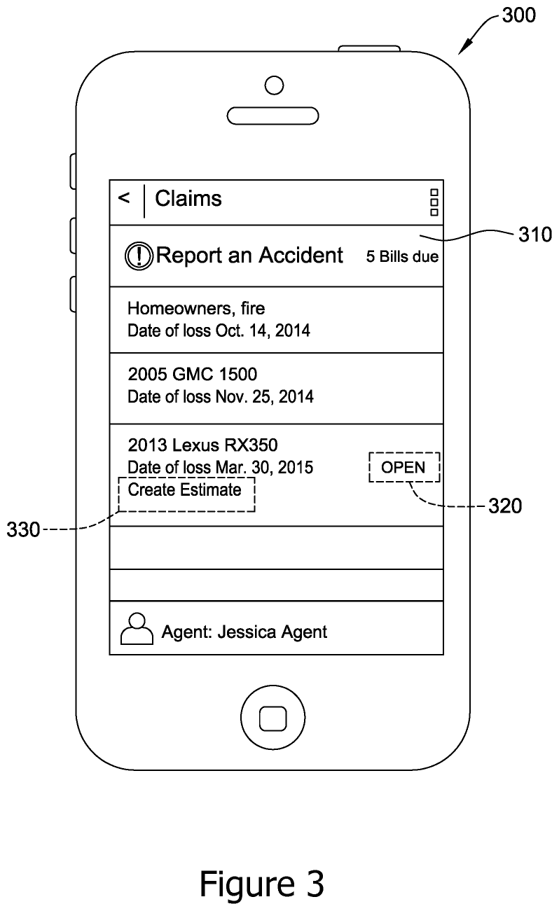

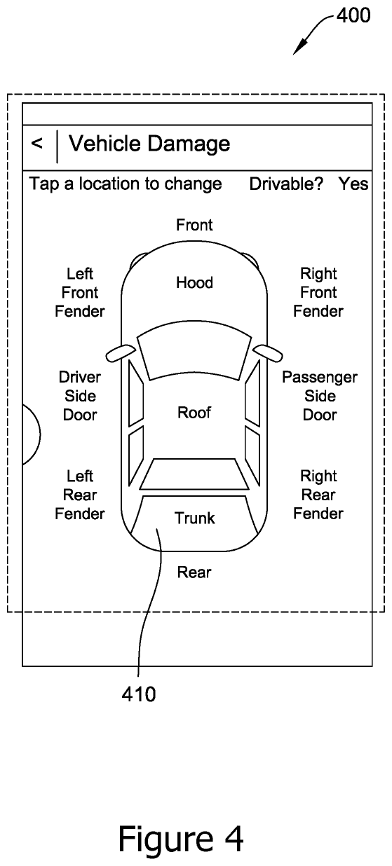

FIGS. 2-4 depicts exemplary user interfaces 200, 300, 400 of an insurance App. The insurance App may be stored on a user computing device of a damages assessment system, such as system 100 shown in FIG. 1. In the exemplary embodiment, user computing device 110 and insurance App 115, both shown in FIG. 1, may include at least one of user interfaces 200, 300, 400. User interfaces 200, 300, 400 may include additional, fewer, or alternative features, including those described elsewhere herein.

User interface 200 may illustrate a home page of an insurance App. A user (e.g., a policy holder) may access insurance-related information through user interface 200. In particular, user interface 200 may include a claims section 210. Claims section 210 may enables the user to view active insurance claims and report new insurance claims.

When claims section 210 is selected, user interface 300 may be displayed. User interface 300 may enable the user to access additional options for new and existing insurance claims. In the exemplary embodiment, user interface 300 may include report option 310, claim status option 320, and/or estimate option 330. Report option 310 may enable the user to report a new insurance claim through the damages assessment system (e.g., system 100, shown in FIG. 1). Claim status option 320 may be configured to provide the user preliminary information on the status of an insurance claim, such as “open” or “closed”. Selecting claim status option 320 may cause the insurance App to provide more information about the selected insurance claim. Estimate option 330 enables the user to begin a request to receive a damage assessment (i.e., a damage assessment) or view an existing damage assessment for the insurance claim. In the exemplary embodiment, estimate option 330 may not be displayed until the damages assessment system determines the user is eligible to access the damages assessment system.

When report option 310 is selected, the insurance App may prompt the user to provide loss information. User interface 400 may be an exemplary user interface for reporting a damaged vehicle. User interface 400 may include an image of a vehicle 410. The user may indicate on vehicle 410 where there is damage on the user's vehicle. The input received from the user may be used to determine the user's eligibility to receive an assessment (e.g., an eligibility test) and/or to generate the damage assessment.

The user computing device may also include a damages module. The damages module may be stored on the user computing device of the damages assessment system, such as system 100 shown in FIG. 1. In the exemplary embodiment, user computing device 110 and damages module 117, both shown in FIG. 1, may be configured to display one or more user interfaces for prompting a user to gather information that is used by the damages assessment system.

For example, when the damages module is authorized or initiated, the damages module may be configured to collect image data associated with the damaged property. One of the user interfaces displayed by user computing device 110 may include a camera interface for gathering the image data using a camera of the user computing device. In the exemplary embodiment, the user computing device may focus on a damaged vehicle associated with the user. The camera interface may include one or more configuration options that enable the user to specify different options when collecting the image data. For example, the configuration options may include a “dent” or “scratch” option indicating what type of damage is in the image. In another example, the configuration options may include a heat map option. In yet another example, the configuration options may include “Undo”, “Reset”, “Back”, and “Next” options.

The damages module may be configured to collect further information from the user to generate a damage assessment. Another user interface may include one or more image options and a submit option. The user may select one image option to cause the damages module to activate a camera interface to collect loss information. The image options may include particular angles of the damaged property, odometer readings for a damaged vehicle, vehicle identification number (VIN) of the damaged vehicle, and/or any other information related to the damaged property. When the user has finished with the image options, the user may select a submit option to transmit the loss information to an assessment computing device to generate the damage assessment.

When the damages module receives the damage assessment, the damages module may cause the damage assessment to be displayed. In one embodiment, the damages module may automatically display the assessment. In another embodiment, the damages module may provide the user an option to view the damage assessment. Another user interface may present the assessment to the user. This assessment user interface may include a report option to view an estimate report. The estimate report may include additional details regarding the damage assessment.

### EXEMPLARY COMPUTER-IMPLEMENTED METHOD FOR INITIATING DAMAGE ASSESSMENTS VIA AN INSURANCE APP

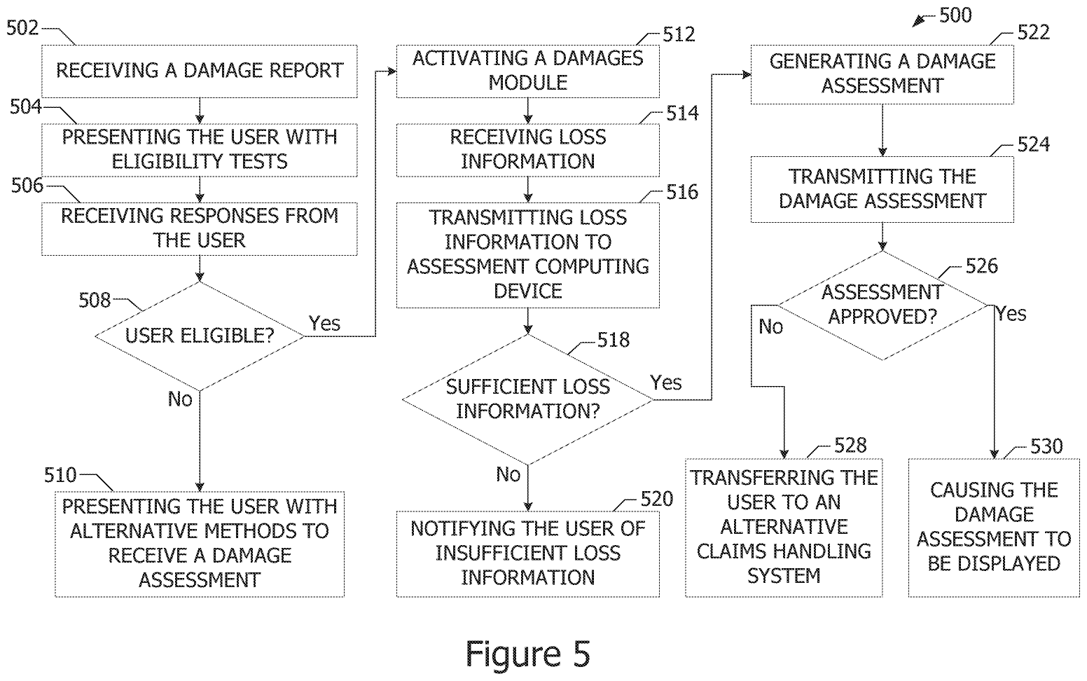

FIG. 5 depicts an exemplary method 500 for providing a damage assessment to a user (e.g., a policy holder). In particular, method 500 may be initiated by the user reporting a damaged property through an insurance App stored on a user computing device. Method 500 may be implemented by a damages assessment system, such as system 100 shown in FIG. 1. Method 500 may include additional, fewer, or alternative steps, including those described elsewhere herein.

Method 500 may begin with the user computing device receiving 502 a damage report (e.g., an insurance claim) within the insurance App from the user. The damages assessment system may determine that the user used the insurance App to submit the damage report and adjusts as described herein. The user computing device may present 804 the user with one or more eligibility tests to determine the user's eligibility to receive a damage assessment. The user computing device may then receive 506 one or more responses to the eligibility tests. In the exemplary embodiment, the user may input the responses into an input device of the user computing device, such as a touch screen, a keyboard, a physical button, a biometric scanner, and/or a microphone. The responses may then be transmitted to a claims processing system and/or an insurance computing device. The claims processing system may identify an insurance computing device to process the damage report and transmit the responses to the identified insurance computing device.

The insurance computing device may determine 508 the user's eligibility to receive a damage assessment based upon the responses. If the user is ineligible, the user computing device may present 510 the user of alternative methods to receive a damage assessment. In some embodiments, the user computing device may provide the user with further details about why he or she is ineligible. The user may be able to correct some issues causing the user to be ineligible and retry method 500. If the user is eligible, the user computing device may activate 512 a damages module to be initiated within the insurance App to collect loss information, such as images of the damaged property. In one embodiment, the user computing device may generate an activation code for the damages module. The damages module may receive 514 the loss information from the user and may transmit 516 the loss information to an assessment computing device. In the exemplary embodiment, the damages module may further transmit a module identifier to enable the assessment computing device to identify the user and/or the user computing device associated with the loss information. The assessment computing device may determine 518 whether the loss information is sufficient to generate a damage assessment. For example, the assessment computing device may require images from certain angles of the damaged property. If the loss information is insufficient, the assessment computing device may notify 520 the user computing device and/or the insurance computing device. If the loss information is sufficient, the assessment computing device may generate 522 the damage assessment based upon the loss information. The assessment computing device may transmit 524 the damage assessment to the user computing device and the insurance computing device. The insurance computing device may review 526 the damage assessment for approval by an insurance provider. If the damage assessment is declined (e.g., the assessment does not meet standards set by the insurance provider), the insurance computing device may transfer 528 the user to an alternative claims handling method or system. If approved, the user computing device may cause 530 the damage assessment to be displayed within the damages module. In certain embodiments, the damages module may enable the user to provide payment information to pay for the damage assessment.

### EXEMPLARY INITIATION OF DAMAGE ASSESSMENTS VIA INTERNET

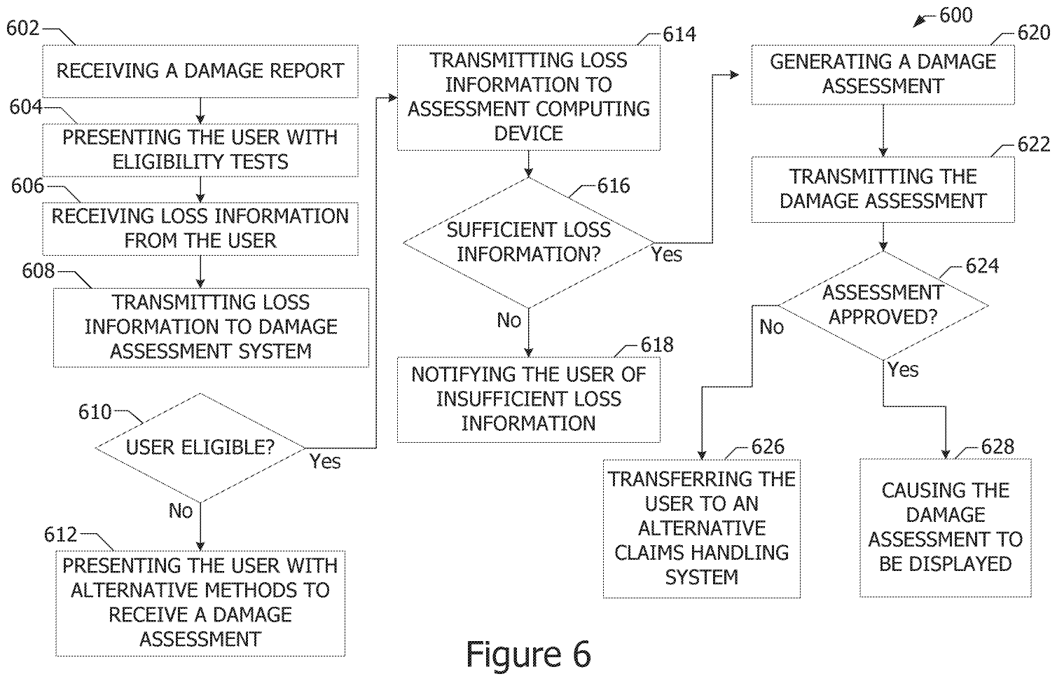

FIG. 6 depicts an exemplary method 600 for providing a damage assessment to a user. In particular, method 600 may be initiated by the user reporting a damaged property through an internet application. The internet application may be a web page or another application accessible by the user from a remote computing device (e.g., user computing device 110, shown in FIG. 1, or another computing device). Method 600 may be implemented by a damages assessment system, such as system 100 shown in FIG. 1. In the exemplary embodiment, the internet application is in communication with the damages assessment system. Method 600 may include additional, fewer, or alternative steps, including those described elsewhere herein.

Method 600 may begin with the user submitting 602 a damage report from the internet application. The internet application may present 604 with one or more eligibility tests. The internet application may further receive 606 loss information from the user. In some embodiments, the internet application may cause the damages module to be launched to collect images of the damaged property to prevent the user from submitting altered images. In certain embodiments, the internet application may transmit an activation code to a user computing device associated with the user to enable the damages module. The internet application may transmit 608 the loss information and/or one or more responses to the eligibility tests to a claims processing system or an insurance computing device in communication with the internet application. The claims processing system may identify an insurance computing device to process the damage report and transmit the responses to the identified insurance computing device.

The insurance computing device may determine 610 the user's eligibility based upon the loss information and/or the responses. If the user is ineligible, the insurance computing device may present 612 the user via the internet application of alternative methods to receive a damage assessment. In some embodiments, the internet application may provide the user with further details about why he or she is ineligible. If the user is eligible, the insurance computing device may transmit 614 the loss information to an assessment computing device. In the exemplary embodiment, the insurance computing device may further transmit a module identifier associated with the user and/or the user computing device associated with the user to the assessment computing device.

The assessment computing device may determine 616 whether the loss information is sufficient to generate a damage assessment. For example, the assessment computing device may require images from certain angles of the damaged property. If the loss information is insufficient, the assessment computing device may notify 618 the user computing device, the insurance computing device, and/or the internet application. If the loss information is sufficient, the assessment computing device may generate 620 a damage assessment based upon the loss information. The assessment computing device may transmit 622 the damage assessment to the user computing device and the insurance computing device. In the exemplary embodiment, the assessment computing device may identify the user computing device using the module identifier. The insurance computing device may review 624 the assessment for approval by an insurance provider. If the damage assessment is declined, the insurance computing device may transfer 626 the user to an alternative claims handling method or system. If approved, the user computing device may cause 628 the damage assessment to be displayed within the damages module. In certain embodiments, the damages module may enable the user to provide payment information to pay for the damage assessment.

### EXEMPLARY INITIATION OF DAMAGE ASSESSMENTS VIA PHONE

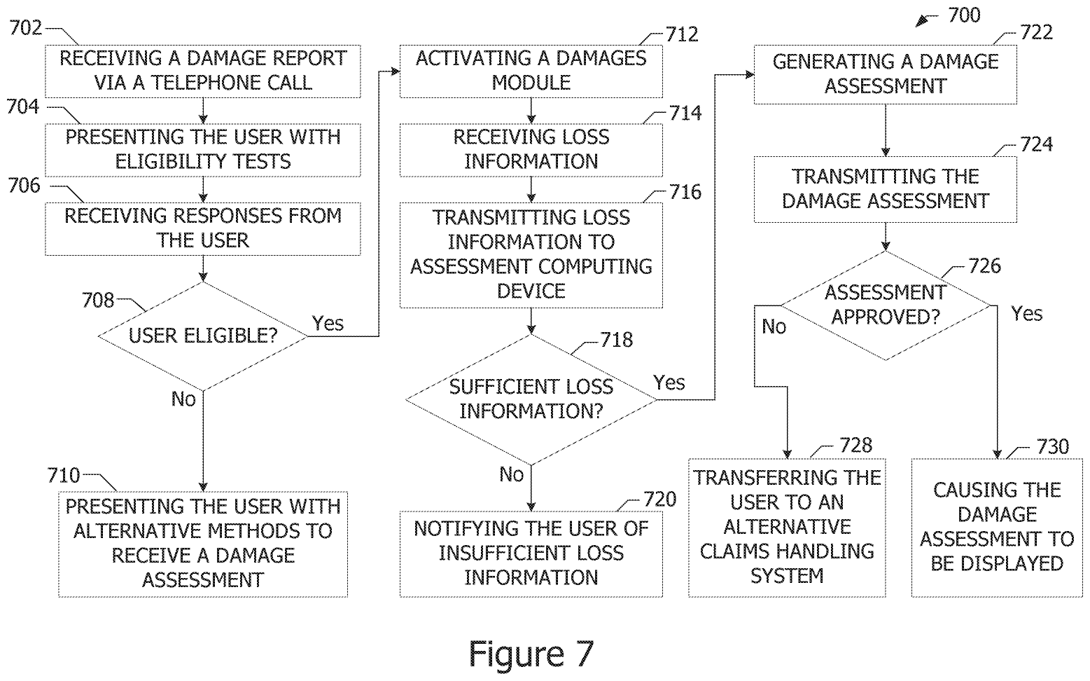

FIG. 7 depicts an exemplary method 700 for providing a damage assessment to a user. In particular, method 700 may be initiated by the user reporting a damaged property through a telephone call with an operator associated with an insurance provider. Method 700 may be initiated with other communication methods, such as email, text message, instant message, and/or video conferencing. In the exemplary embodiment, the operator may be associated with an insurance computing device (e.g., insurance computing device 130, shown in FIG. 1). The operator may be, for example, an insurance agent, an insurance claims adjuster, and/or another person employed by the insurance provider. The operator may input information received from the user into the insurance computing device. Method 700 may be implemented by a damages assessment system, such as system 100 shown in FIG. 1. Method 700 may include additional, fewer, or alternative steps, including those described elsewhere herein.

Method 700 may begin with the operator receiving 702 a telephone call from the user to report the damaged property. The insurance computing device may present 704 the operator with one or more eligibility tests that the operator communicates to the user. The insurance computing device may receive 706 input from the operator representing the user's responses to the eligibility tests. In other embodiments, the insurance computing device may receive 706 the responses from the user. For example, the insurance computing device may be configured to monitor the telephone call for the user's responses.

The insurance computing device may determine 708 the user's eligibility based upon the responses. If the user is ineligible, the insurance computing device may notify 710 the user of alternative methods to receive a damage assessment. In some embodiments, the insurance computing device may provide the user with further details about why he or she is ineligible. In one embodiment, the operator may notify the user. If the user is eligible, the insurance computing device or a claims processing system in communication with the insurance computing device may activate 712 a damages module on a user computing device associated with the user. In certain embodiments, the insurance computing device and/or the claims processing system may transmit an activation code to a user computing device associated with user that stores the damages module. The damages module may collect 714 loss information including one or more images of the damaged property from the user. The user computing device may transmit 716 the loss information to an assessment computing device.

The assessment computing device may determine 718 whether the loss information is sufficient to generate a damage assessment. For example, the assessment computing device may require images from certain angles of the damaged property. If the loss information is insufficient, the assessment computing device may notify 720 the insurance computing device. The operator of the insurance computing device may notify the user. If the loss information is sufficient, the assessment computing device may generate 722 a damage assessment based upon the loss information. The assessment computing device may transmit 724 the assessment to the user computing device and/or the insurance computing device.

The insurance computing device may review 726 the damage assessment for approval by an insurance provider. If the assessment is declined, the insurance computing device may transfer 728 the user to an alternative claims handling method or system. If approved, the user computing device may cause 730 the damage assessment to be displayed within the damages module. In certain embodiments, the damages module may enable the user to provide payment information to pay for the assessment.

### EXEMPLARY COMPUTING DEVICE

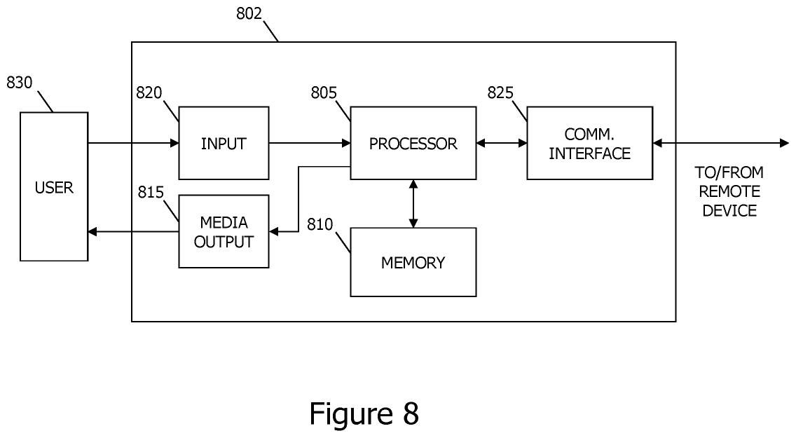

FIG. 8 depicts an exemplary configuration of a computing device 802. Computing device 802 may include, but is not limited to, user computing device 110, assessment computing device 120, insurance computing device 130, and/or claims processing system 140 shown in FIG. 1.

Computing device 802 may include a processor 805 for executing instructions. In some embodiments, executable instructions may be stored in a memory area 810. Processor 805 may include one or more processing units (e.g., in a multi-core configuration). Memory area 810 may be any device allowing information such as executable instructions and/or other data to be stored and retrieved. Memory area 810 may include one or more computer-readable media.

Computing device 802 may also include at least one media output component 815 for presenting information to a user 830. Media output component 815 may be any component capable of conveying information to user 830. In some embodiments, media output component 815 may include an output adapter, such as a video adapter and/or an audio adapter. An output adapter may be operatively coupled to processor 805 and operatively coupleable to an output device such as a display device (e.g., a liquid crystal display (LCD), organic light emitting diode (OLED) display, cathode ray tube (CRT), or “electronic ink” display) or an audio output device (e.g., a speaker or headphones). In some embodiments, media output component 815 may be configured to present an interactive user interface (e.g., a web browser or client application) to user 830. The interactive user interface may include, for example, a reality augmentation interface for requesting and viewing Enhanced Situation Visualization.

In some embodiments, computing device 802 may include an input device 820 for receiving input from user 830. Input device 820 may include, for example, a keyboard, a pointing device, a mouse, a stylus, a touch sensitive panel (e.g., a touch pad or a touch screen), a camera, a gyroscope, an accelerometer, a position detector, and/or an audio input device. A single component such as a touch screen may function as both an output device of media output component 815 and input device 820.

Computing device 802 may also include a communication interface 825, which may be communicatively coupleable to a remote device such as insurance computing device 120 (shown in FIG. 1). Communication interface 825 may include, for example, a wired or wireless network adapter or a wireless data transceiver for use with a mobile phone network (e.g., Global System for Mobile communications (GSM), 3G, 4G or Bluetooth) or other mobile data network (e.g., Worldwide Interoperability for Microwave Access (WIMAX)).

Stored in memory area 810 are, for example, computer-readable instructions for providing a user interface to user 830 via media output component 815 and, optionally, receiving and processing input from input device 820. A user interface may include, among other possibilities, a web browser and client application. Web browsers enable users 830 to display and interact with media and other information typically embedded on a web page or a website from a web server associated with a merchant. A client application allows users 830 to interact with a server application associated with, for example, a vendor or business.

### EXEMPLARY SERVER

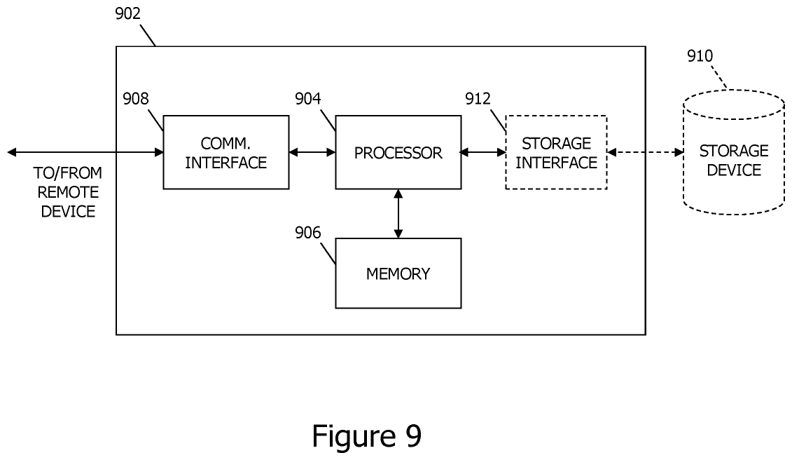

FIG. 9 depicts an exemplary configuration of a server computing device 902. Server computing device 902 may be representative of user computing device 110, assessment computing device 120, insurance computing device 130, and/or claims processing system 140 (all shown in FIG. 1). Server computing device 1202 may include a processor 904 for executing instructions. Instructions may be stored in a memory area 906, for example. Processor 904 may include one or more processing units (e.g., in a multi-core configuration).

Processor 904 may be operatively coupled to a communication interface 908 such that server computing device 902 may be capable of communicating with a remote device such as computing device 802 shown in FIG. 8 or another server computing device 902. For example, communication interface 908 may receive requests from user computing device 902 via the Internet.

Processor 904 may also be operatively coupled to a storage device 910. Storage device 910 may be any computer-operated hardware suitable for storing and/or retrieving data. In some embodiments, storage device 910 may be integrated in server computing device 902. For example, server computing device 902 may include one or more hard disk drives as storage device 910. In other embodiments, storage device 910 may be external to server computing device 902 and may be accessed by a plurality of server computing devices 902. For example, storage device 910 may include multiple storage units such as hard disks or solid state disks in a redundant array of inexpensive disks (RAID) configuration. Storage device 910 may include a storage area network (SAN) and/or a network attached storage (NAS) system.

In some embodiments, processor 904 may be operatively coupled to storage device 910 via a storage interface 912. Storage interface 912 may be any component capable of providing processor 904 with access to storage device 910. Storage interface 912 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 904 with access to storage device 910.

Memory areas 810 (shown in FIGS. 8) and 906 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are example only, and are thus not limiting as to the types of memory usable for storage of a computer program.

### EXEMPLARY ELIGIBILITY TESTS & SCENARIOS

The eligibility tests discussed herein may include one or more questions (also sometimes referred to as “qualifying questions”). For instance, whether or not a customer is permitted access to functionality related to submitting an online insurance claim may be determined based upon a level of damage to the vehicle. The questions asked may include: (1) “Did the vehicle rollover?”; (2) “Was the vehicle flooded by freshwater (above dash), saltwater (above rocker), or brackish water (to the floor)?”; (3) “Is the vehicle burned completely?”; (4) “Is there wheel or suspension damage?”; (5) “Is this a frontal impact?”; (6) “Are the doors jammed?”; (7) “Is the engine disabled?”; and/or (8) “Did the air bags deploy?”

In one scenario, a loss event or vehicle collision may occur. The insurance customer or insured may access Pocket Agent® or another insurance provider website or homepage via wireless communication using their mobile device. At the insurance provider website (i.e., an interne application), the insured may navigate to a webpage that allows the insured to submit loss information. For instance, the insured may acquire and submit photos of their damaged, insured vehicle, and submit other information as well. Photo guidance or instructions may also be provided to the insured via the website. The website may then send the loss information to an insurance provider remote server.

The insurance provider may then determine eligibility for the insured to access insurance claim estimate functionality or otherwise receive an online insurance claim quote. The eligibility of the insured may be determined by asking the insured one or more eligibility questions, including those mentioned elsewhere herein.

In one embodiment, the eligibility questions may be intended to determine the extent of damage to the vehicle. For instance, vehicles with extensive damage may not be eligible to receive an online insurance claim estimate and may need an in person inspection. If the vehicle has extensive damage or is otherwise not eligible for an online estimate, the website may offer the insured an alternate vehicle inspection option.

If the vehicle is eligible for an online estimate, the website or remote server may analyze the photos of the damaged vehicle and other information submitted to determine if it is sufficient to determine an online estimate. Once sufficient information and photos are gathered, an estimate may be generated and/or uploaded to the website or remote server. The estimate may be displayed to the insured on their mobile device. The estimate may also be reviewed by the remote server for accuracy, and a payment may be issued to the insured based upon the estimate and/or in accordance with their auto insurance policy.

In one aspect, a computer-implemented method of generating a damage estimate for a damaged vehicle may be provided. The method may include (1) providing, via one or more processors, an insured's mobile device access to a website; (2) receiving, via the one or more processors, one or more answers to one or more qualifying questions, respectively, from the insured via their mobile device and wireless communication; (3) analyzing, via the one or more processors, the one or more answers to determine an extent of damage to the damaged vehicle and/or whether the damaged vehicle (and/or insured) is eligible to receive an online damage estimate; (4) if the damaged vehicle (and/or insured) is eligible, granting the insured's mobile device, via the one or more processors, access to (i) insurance claim submission, (ii) insurance claim estimation, or (iii) vehicle damage estimation functionality; (5) generating, via the one or more processors, an estimate of vehicle damage; and/or (6) causing the estimate of vehicle damage, via the one or more processors, to be presented on the insured's mobile device for their review and/or approval, such as via wireless communication or data transmission, to enhance an online customer experience.

In another aspect, a computer-implemented method of generating a damage estimate for a damaged vehicle may be provided. The method may include (1) providing, via one or more processors, an insured's mobile device access to a website via wireless communication; (2) receiving, via the one or more processors, one or more photos taken by the insured's mobile device showing damage to the damaged vehicle via the insured's mobile device and wireless communication; (3) receiving, via the one or more processors, one or more answers to one or more qualifying questions regarding an extent and/or type of damage to the damaged vehicle, respectively, from the insured via their mobile device and wireless communication; (4) analyzing, via the one or more processors, the one or more answers to determine an extent of damage to the damaged vehicle and/or whether the damaged vehicle (and/or insured) is eligible to receive an online damage estimate; (5) if the damaged vehicle (and/or insured) is eligible, granting the insured's mobile device, via the one or more processors, access to vehicle damage estimation functionality, and/or generating, via the one or more processors, an estimate of vehicle damage from computer analysis of the one or more photos of the damaged vehicle; and/or (6) causing the estimate of vehicle damage, via the one or more processors, to be presented on the insured's mobile device for their review and/or approval via wireless communication to enhance an online customer experience and/or facilitate online insurance claim submission.

The foregoing methods may include additional, less, or alternate actions, including those discussed elsewhere herein, and may be implemented via one or more local or remote servers, and/or via computer-executable instructions stored on non-transitory computer-readable medium or media. Also, the one or more qualifying questions relate to, a type or an extent of vehicle fire or water damage. Additionally or alternatively, the qualifying questions may relate to location of vehicle damage; engine or door damage; airbag deployment; wheel or suspension damage; flood or storm surge damage; hail damage, or extent thereof; and/or front or rear vehicle damage.

The qualifying questions may expressly ask the insured if certain equipment or systems on the vehicle are still in working condition or damaged. For instance, do the doors or hood still open, or do the headlights still work. In one embodiment, the qualifying questions may allow the one or more processors to determine the type or extent of damage to facilitate allowing low dollar amount claims to be estimated online, and/or associated insurance claims to be submitted online. On the other hand, likely “total loss” vehicles may require an in person inspection. In this respect, the qualifying questions may operate as kickout questions, that if answered in the affirmative, the user is kicked out of the flow and not allowed to access the functionality that will allow (i) submission of damaged vehicle photos, (ii) estimate vehicle damage, and (iii) then allow the insured to submit an associated insurance claim based upon the estimated vehicle damage via their mobile device.

### EXEMPLARY COMPUTER SYSTEMS

In one aspect, a computer system configured to generate a damage estimate for a damaged vehicle may be provided. The system may include one or more processors configured to: (1) provide an insured's mobile device access to a website; (2) receive one or more answers to one or more qualifying questions, respectively, from the insured via their mobile device and wireless communication; (3) analyze the one or more answers to determine an extent of damage to the damaged vehicle and/or whether the damaged vehicle (and/or insured) is eligible to receive an online damage estimate; (4) if the damaged vehicle (and/or insured) is eligible, grant the insured's mobile device access to (i) insurance claim submission, (ii) insurance claim estimation, and/or (iii) vehicle damage estimation functionality; (5) generate an estimate of vehicle damage; and/or (6) cause the estimate of vehicle damage to be presented on the insured's mobile device for their review and/or approval, such as via wireless communication or data transmission, to enhance an online customer experience and facilitate online insurance claim submission. The system may include additional, less, or alternate functionality, including that discussed elsewhere herein.

In another aspect, a computer system for generating a damage estimate for a damaged vehicle may be provided. The system may include one or more processors configured to: (1) provide an insured's mobile device access to a website via wireless communication; (2) receive one or more photos taken by the insured's mobile device showing damage to the damaged vehicle via the insured's mobile device and wireless communication; (3) receive one or more answers to one or more qualifying questions regarding an extent and/or type of damage to the damaged vehicle, respectively, from the insured via their mobile device and wireless communication; (4) analyze the one or more answers to determine an extent of damage to the damaged vehicle and/or whether the damaged vehicle (and/or insured) is eligible to receive an online damage estimate; (5) if the damaged vehicle (and/or insured) is eligible, grant the insured's mobile device access to vehicle damage estimation functionality, and/or generate an estimate of vehicle damage from computer analysis of the one or more photos of the damaged vehicle; and/or (6) cause the estimate of vehicle damage to be presented on the insured's mobile device for their review and/or approval via wireless communication to enhance an online customer experience and facilitate online insurance claim submission. The system may include additional, less, or alternate functionality, including that discussed elsewhere herein.

### ADDITIONAL CONSIDERATIONS

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “Apps”, or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

In one embodiment, a computer program is provided, and the program is embodied on a computer readable medium. In an example embodiment, the system is executed on a single computer system, without requiring a connection to a sever computer. In a further embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein.

In addition, components of each system and each process can be practiced independent and separate from other components and processes described herein. Each component and process can also be used in combination with other assembly packages and processes.

As used herein, an element or step recited in the singular and preceded by the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

The patent claims at the end of this document are not intended to be construed under 35 U.S.C. § 112(f) unless traditional means-plus-function language is expressly recited, such as “means for” or “step for” language being expressly recited in the claim(s).

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A computer-based method for generating a damage assessment for a damaged property, said method implemented using an insurance computing device in communication with a user computing device that stores an application in a memory thereof, the application including a damages module that is inaccessible without an activation code, said method comprising:
receiving, from a communication means other than the damages module, a damage report from a user associated with the damaged property;
retrieving insurance policy data associated with one of the user and the damaged property;
determining, based upon the retrieved insurance policy data, whether the user is eligible to access the damages module of the application stored in the memory of the user computing device, and when the user is not eligible:
transmitting an eligibility test to the user, wherein the eligibility test includes at least one question associated with damage to the damaged property, and wherein the eligibility test relates to an extent of damage incurred by the damaged property;
receiving a response to the eligibility test from the user; and
determining, based upon the response to the eligibility test, to provide the user with access to the damages module;
transmitting the activation code to the application stored on the user computing device to cause the user computing device to provide the user with access to the damages module on the application, wherein providing the user with access to the damages module includes activating a camera interface configured to collect loss information by enabling the user to capture at least one image of the damaged property;
receiving, in response to the user gaining access to the damages module, the loss information from the damages module, wherein the loss information includes the at least one image of the damaged property;
generating a damage assessment based upon the loss information; and
transmitting the damage assessment to the user.

2. The computer-based method of claim 1 further comprising transmitting the loss information to an assessment computing device configured to generate the damage assessment.

3. The computer-based method of claim 2 further comprising:
receiving the damage assessment from the assessment computing device; and
causing the damage assessment to be displayed on the user computing device.

4. The computer-based method of claim 3, wherein receiving the damage assessment from the assessment computing device further comprises reviewing the damage assessment to approve the damage assessment.

5. The computer-based method of claim 3, wherein transmitting the loss information to the assessment computing device further includes transmitting a module identifier to the assessment computing device, the module identifier associated with the damages module.

6. (canceled)

7. The computer-based method of claim 1, wherein receiving the damage report from the user associated with the damaged property further includes receiving the damage report at the application stored in the memory of the user computing device, wherein transmitting the eligibility test to the user via the application stored in the memory of the user computing device further includes causing the eligibility test to be displayed on the user computing device within a user interface of the application stored in the memory of the user computing device.

8. The computer-based method of claim 1, wherein receiving the damage report from the user associated with the damaged property further includes receiving the damage report from the an internet application associated with the user.

9. The computer-based method of claim 1, wherein receiving the damage report from the user associated with the damaged property further includes receiving the damage report from an operator associated with an insurance provider, the operator in communication with the user, and wherein transmitting the eligibility test to the user further includes the operator communicating the eligibility test to the user.

10. A user computing device configured to collect loss information of a damaged property from a user, the user computing device including at least one processor and a memory in communication with the at least one processor, wherein the at least one processor is programmed to:
store, in the memory of the user computing device, an application including a damages module that is inaccessible without an activation code;
transmit, to an insurance computing device and from a communication means other than the damages module, a damage report associated with the damaged property;
receive, from the insurance computing device, an eligibility test, wherein the eligibility test includes at least one question associated with damage to the damaged property, and wherein the eligibility test relates to an extent of damage incurred by the damaged property and determines whether the user is eligible to use a damages;
prompt the user to input a response to the eligibility test;
transmit the response to the insurance computing device, wherein in response to receiving the response, the insurance computing device is configured to determine whether to provide the user with access to the damages module;
in response to the insurance computing device determining to provide the user with access to the damages module:
receive an activation code, the activation code configured to unlock provide the user with access to the damages module on the application stored in the memory of the user computing device, wherein providing the user with access to the damages module includes activating a camera interface configured to collect loss information by enabling the user to capture at least one image of the damaged property; and
receive, in response to the user gaining access to the damages module, the loss information from the user through the damages module, the loss information including at least one image of the damaged property;
transmit the loss information to an assessment computing device, the assessment computing device configured to generate a damage assessment;
receive the damage assessment; and
cause the damage assessment to be displayed on the user computing device within the damages module.

11. (canceled)

12. The user computing device of claim 10, wherein the at least one processor is further programmed to:
receive indication from an insurance computing device that the user is eligible to receive the damage assessment; and
cause the user computing device to display the damages module, wherein the damages module is configured to prompt the user for the loss information.

13. The user computing device of claim 10, wherein the damages module of the application stored in the memory of the user computing device has a module identifier associated therewith, and wherein the at least one processor is further programmed to transmit the module identifier with the loss information.

14. The user computing device of claim 10, wherein the at least one processor is further programmed to:
receive payment information from the user to pay the damage assessment.

15. (canceled)

16. An insurance computing device including at least one processor and a memory in communication with the at least one processor, wherein the insurance computing device is in communication with a user computing device that stores an application in a memory thereof, the application including a damages module that is inaccessible without an activation code, and wherein the at least one processor is programmed to:
receive, from a communication means other than the damages module, a damage report from a user associated with a damaged property;
retrieve insurance policy data associated with one of the user and the damaged property;
determine, based upon the retrieved insurance policy data, whether the user is eligible to access the damages module of the application stored in the memory of the user computing device, and when the user is not eligible:
transmit an eligibility test to a user, wherein the eligibility test includes at least one question associated with damage to the damaged property, and wherein the eligibility test relates to an extent of damage incurred by the damaged property;
receive a response to the eligibility test from the user; and
determine, based upon the response to the eligibility test, to provide the user access to the damages module;
notify an assessment computing device that the user is eligible, wherein the assessment computing device is configured to, in response to being notified that the user is eligible, transmit the activation code to the application stored in the memory of the user computing device to cause the user computing device to provide the user with access to the damages module of the application, wherein providing the user with access to the damages module includes activating a camera interface configured to collect loss information by enabling the user to capture at least one image of the damaged property;
receive, in response to the user gaining access to the damages module, the loss information from the damages module, wherein the loss information includes at least one image of the damaged property;
generate a damage assessment upon receiving loss information from the damages module; and
transmit the damage assessment to the user.

17. The insurance computing device of claim 16, wherein the at least one processor is further configured to:
receive the damage assessment from the assessment computing device;
review the damage assessment to determine if the damage assessment is approved; and
notify the user in response to approving the damage assessment.

18. The insurance computing device of claim 17, wherein the at least one processor is further programmed to provide the user an alternative insurance claims handling method in response to a decline of the damage assessment.

19. The insurance computing device of claim 16, wherein the at least one processor is further programmed to transmit a module identifier associated with the damages module of the application stored in the memory of the user computing device to the assessment computing device, wherein the module identifier enables the assessment computing device to transmit the damage assessment to a user computing device associated with the user.

20. The insurance computing device of claim 16, wherein the at least one processor is further programmed to:
receive a damage report, wherein the damage report is communicated by the user to an operator associated with the insurance computing device in a telephone call;
present the eligibility test to the operator, wherein the operator communicates the eligibility test to the user; and
receiving input from the operator, the input representing the response to the eligibility test from the user.

21. (canceled)

22. The computer-based method of claim 1, said method further comprising, when the user is eligible based upon the retrieved insurance policy data:
transmitting the activation code to the application stored in the memory of the user computing device without transmitting the eligibility test, the activation code causing the user computing device to unlock the damages module on the application.

23. The computer-based method of claim 1, said method further comprising, prior to determining to provide the user with access to the damages module, disabling the damages module at the user computing device.
